(19) United States
(12) Patent Application Publication
(10) Pub. No.: US 2016/0236499 A1
(43) Pub. Date: Aug. 18, 2016

(54) BLANKET FOR TRANSFERRING A PASTE IMAGE FROM ENGRAVED PLATE TO SUBSTRATE

(71) Applicant: LEE CHANG YUNG CHEMICAL INDUSTRY CORPORATION, Kaohsiung City (TW)

(72) Inventors: Hsin-Jung LIN, Taipei City (TW); Chuan-Jen FU, Nantou County (TW); Ruoh-Huey UANG, Hsinchu County (TW)

(21) Appl. No.: 14/620,686

(22) Filed: Feb. 12, 2015

(51) Int. Cl. B41N 10/04

(52) U.S. Cl. CPC B41N 10/04

(57) ABSTRACT

A blanket for transferring a paste image from an engraved plate to a substrate is provided. The blanket includes a foam, a PET layer on the foam, and an paste transfer layer on the PET layer. The blanket has a Tan δ value of 0.05 to 0.13. The foam can be made of polyurethane, polyethylene, nitrile-butadiene rubber, silicone, or a combination thereof. The paste transfer layer can be made of silicone rubber, fluoro rubber, fluorosilicone rubber, a combination thereof, or a multi-layered structure thereof.

### BACKGROUND

1. Technical Field

The disclosure relates to gravure offset printing, and in particular it relates to a blanket of the gravure offset printing.

2. Description of the Related Art

Printed electronic products possess great market potential. There is a continuing goal to miniaturize. To satisfy the design requirements of lighter, smaller, or thinner products, the volume of each component utilized in the product is strictly limited. Taking conductive wires—the most common component in printed electronic products—as an example, the line width thereof is reduced from the hundred-micron scale to a scale of just several microns. Screen printing is typically used in the manufacture of traditional conductive wires. However, the mass-producible line width is only down to 70 μm due to the intrinsic limitations of the screen. Obviously, such a process capability is insufficient for processing currently popular touch panels. To achieve fine wire production, most manufacturers rely on photolithographic technology. Although this process can produce wires with a line width less than 10 micron, the production cost is significantly higher than that of the printing process. Moreover, this process is not environmentally friendly because of the huge consumption of energy and materials.

To meet the production capacity of thin conductive paths and manufacturing cost considerations, gravure transfer (gravure offset printing) technology has seen a lot of research and trial production in industry in recent years, but the blanket of the gravure offset printing still needs to be improved. For example, the Tan δ of conventional blankets is overly high, and it may result in distortion of the printed line width, blanket aging, and the like.

Accordingly, a novel blanket to solve the above problems is called for.

### BRIEF SUMMARY

One embodiment of the disclosure provides a blanket for transferring a paste image from an engraved plate to a substrate, comprising: a foam; a PET layer on the foam; and an paste transfer layer on the PET layer, wherein the blanket has a Tan δ value of 0.05 to 0.13.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a flowchart of the gravure offset printing process in one embodiment of the disclosure;

FIG. 2A-2E show schematic views of various stages of the gravure offset printing process in one embodiment of the disclosure; and

FIG. 3 shows a schematic view of the blanket in one embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

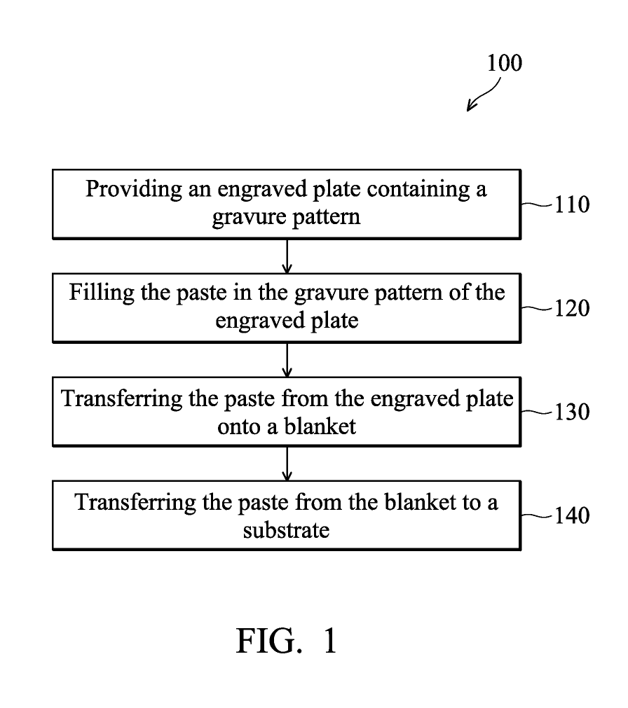

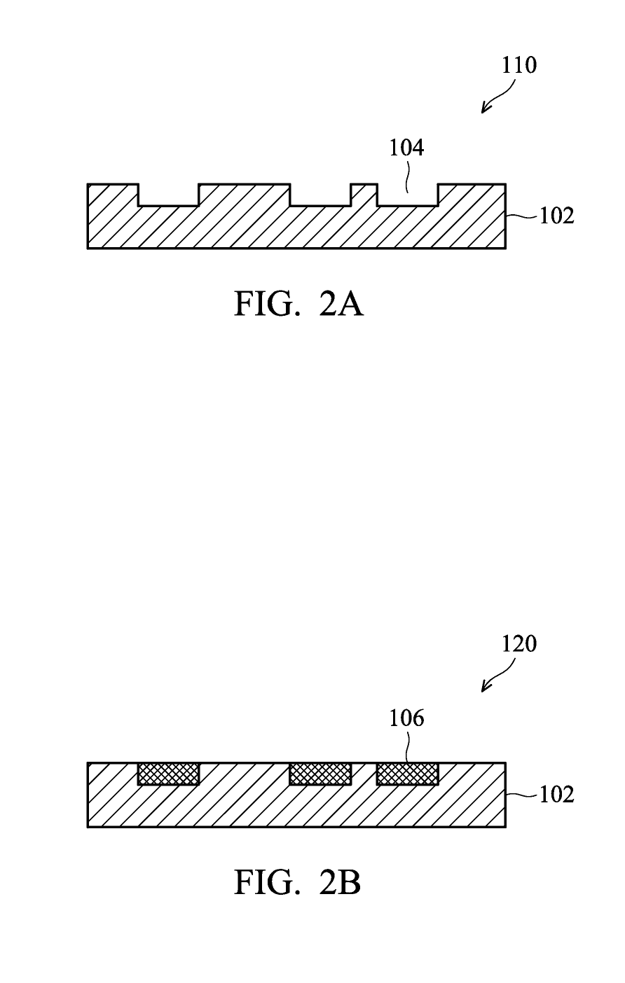

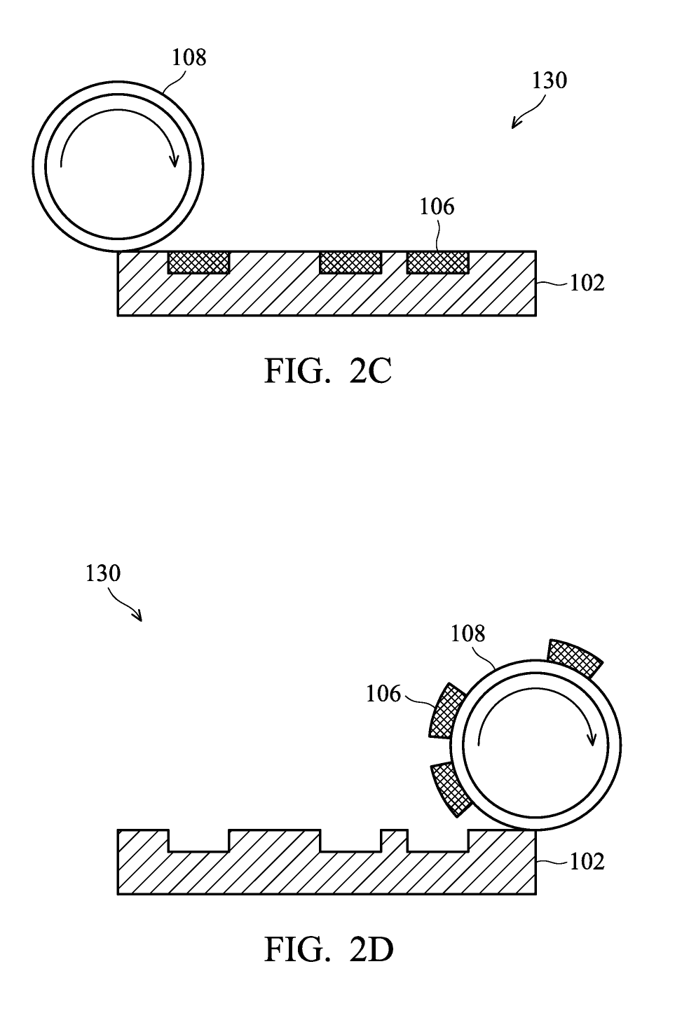

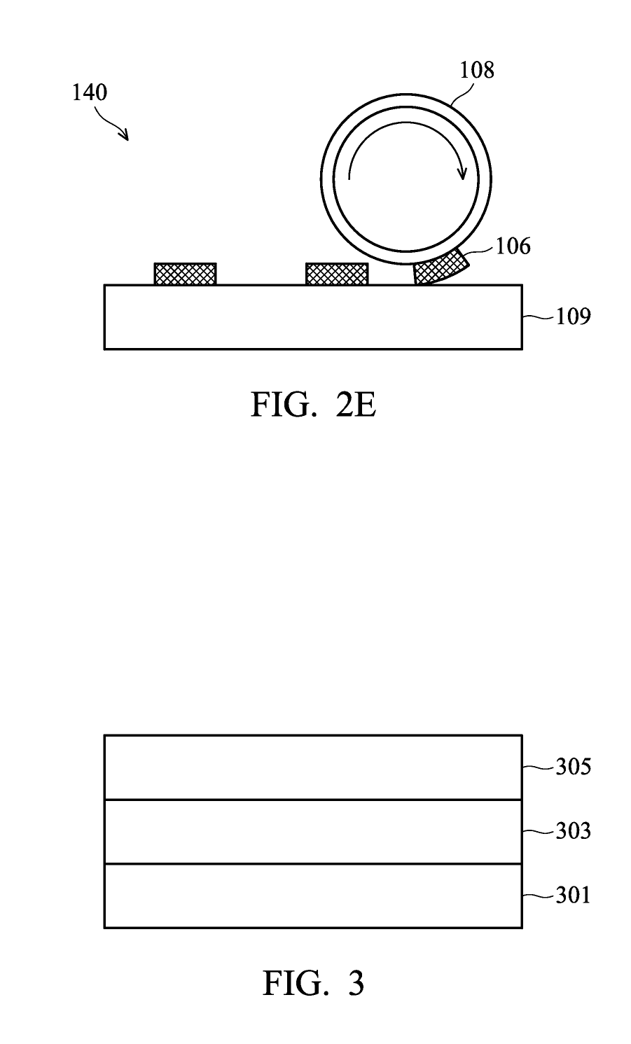

In one embodiment, a gravure transfer process flow is provided as shown in FIG. 1. Process 100 begins at step 110, in which an engraved plate 102 with an intaglio pattern 104 is provided. As shown in FIG. 2A, the intaglio pattern 104 may have a line width between about 3 μm to about 100 μm, for example. The engraved plate 102 can be made of stainless steel, glass, ceramic, copper, or a combination thereof. Subsequently, a paste 106 is filled into the intaglio pattern 104 in step 120. The excess paste 106 over the surface of the engraved plate 102 can be removed by a doctor blade, such that the top surface of the engraved plate 102 is flat, as shown in FIG. 2B. In one embodiment, the paste 106 can be made of metal particles, polymer binder, and organic solvent.

Referring to FIG. 2C, the process 100 proceeds to step 130, in which the paste 106 in the intaglio pattern 104 is transferred to the surface of a blanket 108. The blanket 108 may be a roller shape, for example, In one embodiment, the blanket 108 is a three-layered structure of a foam 301, a PET layer 303 on the foam 301, and an paste transfer layer 305 on the PET layer 303, as shown in FIG. 3. The three-layered structure can be rolled as a roll (the blanket 108 in FIG. 2C), and the paste transfer layer 305 is the outermost layer to transfer the paste 106. The blanket 108 has a Tan δ value of 0.05 to 0.13. A higher Tan δ value means that the blanket has a lower recovery ability when deformed by stress. When stress is applied to a viscoelastic body, the body will flow and deform. Even if the stress is removed, the deformed viscoelastic body cannot completely recover. The recovered part of the body is the so-called storage modulus (e.g. elastic part, E′), and the un-recovered part of the body is the so-called loss modulus (e.g. viscos part, E″). The loss modulus (E″) divided by the storage modulus (E′) is the Tan δ value. The lower Tan δ means the viscoelastic body is close to the ideal elastic body. A blanket with an overly high Tan δ value may have poor ability to recover to its original shape after the printing pressure being released, and its lifetime is decreased. A blanket with an overly low Tan δ value may have poor ability to absorb the solvent of the paste and lead to poor printing results.

In one embodiment, the foam 301 can be made of polyurethane, polyethylene, nitrile-butadiene rubber, silicone, or a combination thereof with a weight average molecular weight of 2,000 to 1,000,000. In one embodiment, the foam 301 has a thickness of 0.5 mm to 1.5 mm. Overly thick foam may lead little blanket engagement into gravure so that paste off ratio will be decreased. Overly thin foam may lead poor supporting ability so that the lifetime of blanket will be decreased.

In one embodiment, the PET in the PET layer 303 has a weight average molecular weight of 15000 to 40000. In one embodiment, the PET layer 303 has a thickness of 100 μm to 300 μm. An overly thick PET layer may lead overly high hardness of blanket. An overly thin PET layer may lead overly low supporting capacity of blanket.

In one embodiment, the paste transfer layer 305 can be made of silicone rubber, fluoro rubber, fluorosilicone rubber, a combination thereof, or a multi-layered structure thereof. The paste transfer layer 305 may have a Shore A hardness of 40 to 60. A paste transfer layer with an overly high Shore A hardness may lead the insufficiency of blanket engagement into gravure. A paste transfer layer with an overly low Shore A hardness may lead blanket without the ability to maintain the shape of printing pattern. In one embodiment, the paste transfer layer 305 has a thickness of 0.3 to 1.5 mm. An overly thick paste transfer layer 305 may lead too much strain remained in blanket so that printing shape will twist and distort. An overly thin paste transfer layer 305 may lead whole blanket composite is too hard to print moderately, which results from the hardness of PET dominate the hardness of the whole blanket. The surface of the paste transfer layer 305 and water may have a contact angle of 105° to 125°. An overly low contact angle means the paste transfer layer 305 is more hydrophilic, and it may keep too much paste on blanket and cannot get 100% paste transfer. An overly high contact angle means the paste transfer layer 305 is too hydrophobic, and it may have poor ability to take paste form gravure. Moreover, an adhesive (not shown) can be disposed between the foam 301 and the PET layer 303, between the PET layer 303 and the paste transfer layer 305, or a combination thereof. The adhesive may further enhance the adhesion between the layers in the blanket 108, thereby eliminating the chance of delamination during the gravure transfer process. The adhesive can be made of silicone, epoxy, silane, or a combination thereof.

Referring to FIG. 2D, the process 100 proceeds to step 140, in which the paste 106 on the blanket 108 is transferred to a substrate 109. Note that although the substrate 109 is shown as being planar, the disclosure is not limited thereto. For example, the substrate 109 can be curved. The substrate 109 can be made of a rigid substrate or a flexible-type substrate, i.e. glass, polyethylene terephthalate (polyethylene terephthalate; PET), polycarbonate (PC), or a combination thereof.

It should be understood that the yield of the gravure transfer process is determined on two critical points: (1) the yield of the paste 106 transferred from the engraved plate 102 to the blanket 108, and (2) the yield of the paste 106 transferred from the blanket 108 to the substrate 109. In other words, the paste 106 tends to attach to the substrate 109 rather than attach to the blanket 108, and it also tends to attach to the blanket 108 rather than to the engraved plate 102. The above attachment can be controlled by the pressure/temperature between the engraved plate 102 and the blanket 108 as well as between the blanket 108 and the substrate 109. Furthermore, the Tan δ value (0.05 to 0.13) of the blanket 108 is critical for the product yield. While the gravure transfer process is a continuous process, a stable blanket 109 may prevent the distortion of the printed line width and blanket aging.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Comparative Example 1

A PET layer with a thickness of 250 μm and Mw of about 25000 (commercially available from ShinKong Materials Technology Co., Ltd.) was adhered on a foam (W-ADH-black-1.0, commercially available from Fujikura) by silicone (SL989, commercially available from STARSILICONE). A silicone layer with a thickness of 0.75 mm and a Shore A hardness of 50 (KE-951U, commercially available from Shin-Etsu Slicone Taiwan co.) was adhered on the PET layer by silicone (SL989, commercially available from STARSILICONE) to complete a blanket. The silicone layer served as a paste transfer layer of the blanket, and the surface of the silicone layer and water had a contact angle of 110°. The blanket had a Tan δ value of 0.13 to 0.2.

A paste made from silver particles, polymer binder, and organic solvent was filled into an intaglio pattern of an engraved plate of stainless-steel or nickel, and the intaglio pattern had a depth of 10 μm and a width of 15 μm. The blanket (on a roll) was pressed to the engraved plate by a pressure of 100N to transfer the paste from the intaglio pattern onto the blanket. The blanket was then pressed to a substrate made of poly(ethylene terephthalate) by a pressure of 180N to transfer the paste from the blanket onto the substrate. However, the paste pattern on the substrate was deformed compared to the intaglio pattern, especially in the corner part of the paste pattern.

### Example 1

A PET layer with a thickness of 250 μm and Mw of about 25000 (commercially available from ShinKong Materials Technology Co., Ltd.) was adhered on a polyurethane foam with a thickness of 1.6 mm (AM60HD, commercially available from Adheso) by silicone (SL989, commercially available from STARSILICONE). A silicone layer with a thickness of 0.75 mm and a Shore A hardness of 50 (KE-951U, commercially available from Shin-Etsu Slicone Taiwan co.) was adhered on the PET layer by silicone (SL989, commercially available from STARSILICONE) to complete a blanket. The silicone layer served as a paste transfer layer of the blanket, and the surface of the silicone layer and water had a contact angle of 110°. The blanket had a Tan δ value of 0.08 to 0.1.

A paste made from silver particles, polymer binder, and organic solvent was filled into an intaglio pattern of an engraved plate of stainless-steel or nickel, and the intaglio pattern had a depth of 10 μm and a width of 15 μm. The blanket (on a roll) was pressed to the engraved plate by a pressure of 100N to transfer the paste from the intaglio pattern onto the blanket. The blanket was then pressed to a substrate poly(ethylene terephthalate) by a pressure of 180N to transfer the paste from the blanket onto the substrate. The paste pattern on the substrate was not deformed compared to the intaglio pattern.

### Example 2

A PET layer with a thickness of 250 μm and Mw of about 25000 (commercially available from ShinKong Materials Technology Co., Ltd.) was adhered on a polyurethane foam with a thickness of 1.6 mm (AM60HD, commercially available from Adheso) by silicone (SL989, commercially available from STARSILICONE). A silicone layer with a thickness of 0.75 mm and a Shore A hardness of 40 (KET-8840, commercially available from Shin-Etsu Slicone Taiwan co.) was adhered on the PET layer by silicone (SL989, commercially available from STARSILICONE) to complete a blanket. The silicone layer served as a paste transfer layer of the blanket, and the surface of the silicone layer and water had a contact angle of 113°. The blanket had a Tan δ value of 0.07 to 0.11.

A paste made from silver particles, polymer binder, and organic solvent was filled into an intaglio pattern of an engraved plate of stainless-steel or nickel, and the intaglio pattern had a depth of 15 μm and a width of 15 μm. The blanket (on a roll) was pressed to the engraved plate by a pressure of 100N to transfer the paste from the intaglio pattern onto the blanket. The blanket was then pressed to a substrate poly(ethylene terephthalate) by a pressure of 180N to transfer the paste from the blanket onto the substrate. The paste pattern on the substrate was not deformed compared to the intaglio pattern.

### Comparative Example 2

A PET layer with a thickness of 250 μm and Mw of about 25000 (commercially available from ShinKong Materials Technology Co., Ltd.) was adhered on a polyurethane foam with a thickness of 1.6 mm (AM60HD, commercially available from Adheso) by silicone (SL989, commercially available from STARSILICONE). A silicone mixture layer with a thickness of 0.75 mm and a Shore A hardness of 60 (mixture of KET-8540 and KET-8580, commercially available from Shin-Etsu Slicone Taiwan co.) was adhered on the PET layer by silicone (SL989, commercially available from STARSILICONE) to complete a blanket. The silicone mixture layer served as a paste transfer layer of the blanket, and the surface of the silicone layer and water had a contact angle of 110.7°. The blanket had a Tan δ value of 0.1 to 0.14.

A paste made from silver particles, polymer binder, and organic solvent was filled into an intaglio pattern of an engraved plate of stainless-steel or nickel, and the intaglio pattern had a depth of 15 μm and a width of 15 μm. The blanket (on a roll) was pressed to the engraved plate by a pressure of 100N to transfer the paste from the intaglio pattern onto the blanket. The blanket was then pressed to a substrate poly(ethylene terephthalate) by a pressure of 180N to transfer the paste from the blanket onto the substrate. The paste pattern on the substrate had a lot of bubbles in its corner.

Accordingly, the blanket with a Tan δ value out of 0.05 to 0.13 (i.e. Comparative Examples 1 and 2) would degrade the paste pattern.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A blanket for transferring a paste image from an engraved plate to a substrate, comprising:
a foam;
a PET layer on the foam; and
a paste transfer layer on the PET layer,
wherein the blanket has a Tan δ value of 0.05 to 0.13.

2. The blanket as claimed in claim 1, wherein the foam comprises polyurethane, polyethylene, nitrile-butadiene rubber, silicone, or a combination thereof.

3. The blanket as claimed in claim 2, wherein the polyurethane, polyethylene, nitrile-butadiene rubber, or silicone has a weight average molecular weight of 2,000 to 1,000,000.

4. The blanket as claimed in claim 1, wherein the foam has a thickness of 0.5 mm to 1.5 mm.

5. The blanket as claimed in claim 1, wherein the PET layer has a weight average molecular weight of 15000 to 40000.

6. The blanket as claimed in claim 1, wherein the PET layer has a thickness of 100 μm to 300 μm.

7. The blanket as claimed in claim 1, wherein the paste transfer layer comprises silicone rubber, fluoro rubber, fluorosilicone rubber, a combination thereof, or a multi-layered structure thereof.

8. The blanket as claimed in claim 1, wherein the paste transfer layer has a Shore A hardness of 40 to 60.

9. The blanket as claimed in claim 1, wherein a surface of the paste transfer layer and water have a contact angle of 105° to 125°.

10. The blanket as claimed in claim 1, wherein the paste transfer layer has a thickness of 0.3 mm to 1.5 mm.

11. The blanket as claimed in claim 1, further comprising an adhesive between the foam and the PET layer, between the PET layer and the paste transfer layer, or a combination thereof.

12. The blanket as claimed in claim 1, wherein the blanket has a Tan δ value of 0.07 to 0.11.

13. The blanket as claimed in claim 1, wherein the blanket has a Tan δ value of 0.08 to 0.10.
